(19) United States
(12) Patent Application Publication
(10) Pub. No.: US 2026/0093245 A1
(43) Pub. Date: Apr. 2, 2026

(54) AI-based System and Method for Optimizing Lot Dispatching in Semiconductor Fabrication Using Reinforcement Learning and Fab-wide Digital Twin

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/900,735

(22) Filed: Sep. 28, 2024

(51) Int. Cl. G05B 19/418

(52) U.S. Cl. CPC G05B 19/41885; G05B 19/41865; G05B 19/41875; G05B 2219/2602

(57) ABSTRACT

Disclosed herein is an AI-based system and method for optimizing lot dispatching in a semiconductor Fab using reinforcement learning (RL) and a Fab-wide digital twin. The system leverages a policy neural network and Monte Carlo Tree Search (MCTS) to enhance cycle time, output, and on-time delivery. The RL agent continuously trains in the background, adapting to changes in Fab operations, ensuring optimized real-time decision-making.

### FIELD OF THE INVENTION

The present invention relates to the field of semiconductor manufacturing, and more particularly to systems and methods for optimizing lot dispatching in semiconductor fabrication facilities (Fabs). The invention utilizes advanced artificial intelligence (AI) techniques, including reinforcement learning (RL) and digital twin technology, to improve cycle time, increase output, and ensure on-schedule delivery in semiconductor production.

### BACKGROUND OF THE INVENTION

In semiconductor fabrication, the efficient dispatching of lots across various process systems is crucial for optimizing production performance. The ability to minimize cycle time, maximize output, and consistently meet on-schedule delivery (OSD) targets directly impacts the competitiveness and profitability of semiconductor manufacturers. As semiconductor technology advances, the complexity of fabrication processes has increased, requiring more sophisticated methods for managing and optimizing operations within the Fab.

Conventional approaches to lot dispatching rely on rule-based systems or heuristic algorithms that, while effective to a certain extent, often lack the flexibility and adaptability needed to handle the dynamic and complex environment of modern Fabs. These methods may struggle to account for the variability in process conditions, equipment availability, and other factors that can affect production efficiency.

Digital twin technology, which creates a virtual replica of physical systems, has emerged as a powerful tool for modeling and simulating Fab operations. By integrating real-time data from sensors and other sources, digital twins provide valuable insights into the current state of the Fab and help predict future states. However, the potential of digital twins to optimize lot dispatching has not been fully realized.

Reinforcement learning (RL), a type of machine learning where an agent learns to make decisions through interaction with its environment, offers a promising solution to this opportunity. Despite its success in other domains, RL has not been applied to the critical area of lot dispatching in semiconductor fabrication. The complexity of Fab operations and the need for continuous adaptation to changing conditions have made RL an ideal candidate for this task.

The present invention addresses this gap by introducing an AI-based system that integrates RL with a Fab-wide digital twin to optimize lot dispatching in semiconductor Fabs. This approach not only improves cycle time, output, and on-schedule delivery but also continuously adapts to the dynamic nature of Fab operations, making it a significant advancement over existing methods.

### SUMMARY

In some embodiments, the present invention relates to an AI-based system and method for optimizing lot dispatching in Fabs by integrating a Fab-wide digital twin with a RL process. The system leverages advanced AI technologies, including a policy neural network, Monte Carlo Tree Search (MCTS), and continuous autonomous training, to improve the efficiency and effectiveness of Fab operations.

In certain implementations, the Fab-wide digital twin operates as a comprehensive virtual representation of the various process systems within the Fab, including lithography, etching, deposition, cleaning, implantation, diffusion, metallization, chemical mechanical planarization (CMP), and metrology. These process systems are grouped based on their manufacturing capacities. The digital twin not only mirrors the current physical state of the Fab but also predicts future states, a critical feature for managing the complex, dynamic Fab environment.

The RL process is fundamental to training a policy neural network that aids decision-making by optimizing lot selection when a process system becomes available. An RL agent interacts with the Fab-wide digital twin, processing inputs such as the states of process systems (e.g., available capacities) and lots (e.g., current processing step, required capacities, and predicted delivery date). The system also factors in the predicted future availability of process systems for a predefined time window. Detailed digital twins for specific process systems provide data that enhances decision-making by reflecting real-time Fab conditions.

In one aspect, the policy neural network comprises multiple layers, including an input layer that processes the states of process systems and lots, and an output layer that generates probability distributions for lot selection. Each decision made by the RL agent, such as selecting a lot for processing, forms a state-action pair, represented as a node within a decision network. This network evolves as the RL process advances, with the policy neural network guiding decisions to maximize rewards based on predicted outcomes.

In some implementations, the RL agent utilizes the MCTS algorithm to explore potential future states. MCTS refines the RL agent's strategy by simulating different actions and their consequences, optimizing decision-making in a Fab environment.

The policy neural network undergoes continuous and autonomous training, similar to the method used in systems like AlphaGo. The RL agent initiates training by interacting with the Fab-wide digital twin, generating episodes composed of multiple scenarios or cases. Each case provides feedback in the form of rewards, which the RL agent uses to update the policy neural network. This continuous training process ensures that the network becomes more proficient at selecting actions that yield higher rewards.

As a result of this continuous training, the policy neural network remains adaptive and capable of responding to changing conditions in the Fab. The RL agent can revisit earlier decisions, regenerate actions, and restart episodes with new strategies, such as the ϵ-greedy algorithm, to ensure comprehensive exploration and avoid local optimization traps.

Once fully trained using synthetic data generated by the Fab-wide digital twin, the policy neural network is deployed for real-time lot dispatching in the Fab. The system's ability to learn and adapt continuously ensures optimized decisions that improve Fab operational efficiency, cycle times, and delivery reliability.

In summary, this invention presents a robust AI-based system that integrates a Fab-wide digital twin with reinforcement learning. By utilizing a policy neural network, MCTS, and continuous autonomous training, the system effectively manages the complex and dynamic environment of a Fab, leading to improved lot dispatching, faster cycle times, and consistent on-schedule delivery.

### BRIEF DESCRIPTION OF THE DRAWINGS

The following brief descriptions pertain to the accompanying drawings, which are intended to enhance the clarity and understanding of the present disclosure:

FIG. 1A: Illustrates a diagram of an exemplary Fab, comprising various process systems clustered into bays according to the system types, with each process system represented by a digital twin.

FIG. 1B: Showcases a functional diagram of an AI machine that controls operations within the Fab. The AI machine includes an AI engine designed to train a policy neural network through an RL process.

FIG. 2: Depicts an exemplary matrix expression of the states of a process system, where each type of process system is associated with a maximum capacity, an available capacity, and a required capacity for a specific duration.

FIG. 3: Depicts an exemplary matrix expression of the states of a lot, where each lot includes a sequence of process steps, with each step associated with a required capacity and duration. The process steps sequentially decrease as the lot progresses through designated process systems.

FIG. 4: Shows a schematic representation of a policy neural network, which is integral to the RL process.

FIG. 5: Reveals a schematic diagram of an exemplary algorithm for RL, utilizing an MCTS program to train the policy neural network.

FIG. 6: Illustrates a flowchart that describes the training of the policy neural network used in the dispatching system through RL.

### DETAILED DESCRIPTIONS

This section delves into specific embodiments of the present invention, aiming to provide a comprehensive understanding. It is important to note that while certain implementations are described to illustrate the inventive aspects clearly, any alterations and modifications that fall within the scope of the appended claims are intended to be encompassed by this disclosure. These detailed descriptions underscore the innovative features of the invention, distinguishing it from existing technologies.

### Terms Used

AI Engine: A core component of an AI system designed to process data, execute machine learning algorithms, and make intelligent decisions. It typically includes software frameworks (e.g., TensorFlow, PyTorch), hardware accelerators (e.g., GPUs, TPUs), and optimized memory systems like HBM. The AI engine efficiently handles complex computations, such as training neural networks and running inference tasks.
AI Machine: A system that uses AI to process data and make decisions autonomously. Typical components include graphics processing units (GPUs) for accelerated computations, high bandwidth memory (HBM) for fast data access, and compute unified device architecture (CUDA) for parallel computing tasks, enabling efficient AI model training and inference.
Continuous Autonomous Training: An ongoing process where an RL agent interacts with a system to train and update a neural network without external intervention.
Cycle Time: The total time required to process a semiconductor lot through all the necessary manufacturing steps.
Fab-wide Digital Twin: A comprehensive virtual model that mirrors and predicts the operational states of various process systems in a semiconductor fabrication facility.
Lot: A group of semiconductor wafers processed together through various manufacturing stages. Each lot moves through different tools and processes, such as lithography, etching, and deposition, to eventually produce finished semiconductor devices. Efficient lot management is crucial for optimizing production and meeting delivery schedules in the Fab.
Lot Dispatching: The process of selecting and assigning semiconductor lots to available process systems for manufacturing steps within a Fab.
Monte Carlo Tree Search (MCTS): An algorithm used to explore potential future states by simulating actions and their consequences to optimize decision-making.
Node: In reinforcement learning (RL), a node represents a specific state of the environment at a given point in time. It encapsulates information about the current situation, such as the conditions and variables that define the environment. The RL agent uses this node to determine the next action, leading to transitions to new nodes (states), forming a trajectory of state-action pairs as the agent interacts with the environment.
On-Schedule Delivery (OSD): The completion and delivery of semiconductor lots by the committed delivery date.
Policy Neural Network: A neural network that maps the current state of an environment to a set of actions, assigning probabilities to each action. It is used in reinforcement learning to optimize decision-making by selecting actions that maximize rewards. In the context of the present invention, the policy neural network processes inputs (e.g., system states, lot status) and generates output actions (e.g., lot selection) for optimizing Fab operations. Weights are adjustable parameters within the network that control how inputs are transformed across layers. These weights are updated during training to improve decision-making by learning from the rewards associated with previous actions.
Process System Digital Twin: A virtual representation of a specific process system within a Fab, such as lithography, etching, or deposition. It mirrors the physical system's real-time status, performance, and behavior.
Reinforcement Learning (RL): A machine learning method where an agent learns to make decisions by interacting with an environment and maximizing cumulative rewards.
Reward: In reinforcement learning (RL), a reward is feedback given to an agent after an action, indicating how beneficial that action was. The agent's goal is to maximize cumulative rewards over time.
RL Agent: An autonomous entity in a reinforcement learning system that interacts with an environment to make decisions. It learns by taking actions in different states of the environment and receiving feedback in the form of rewards. The agent's goal is to optimize its actions over time to maximize cumulative rewards, improving its performance based on the outcomes of previous actions.
States: In reinforcement learning (RL), a state represents the environment at a specific moment, capturing all relevant information the agent needs to make decisions. In the context of a semiconductor Fab, the state includes both process system states—such as the operational status and capacity of equipment—and lot states, which refer to the progress, resource requirements, and delivery timelines of semiconductor lots. These combined states guide the RL agent in optimizing Fab operations.
State-action pair: A combination of a system's current state and the action taken by an RL agent, forming a node in the decision-making network.
Value: The value predicted by a policy neural network represents the expected cumulative reward an RL agent can achieve from a given state. It estimates the long-term benefit of taking certain actions in that state, guiding the agent's decision-making to maximize future rewards.
ϵ-greedy algorithm: A strategy in RL that balances exploration (trying new actions) and exploitation (using known information to make decisions) to optimize learning.

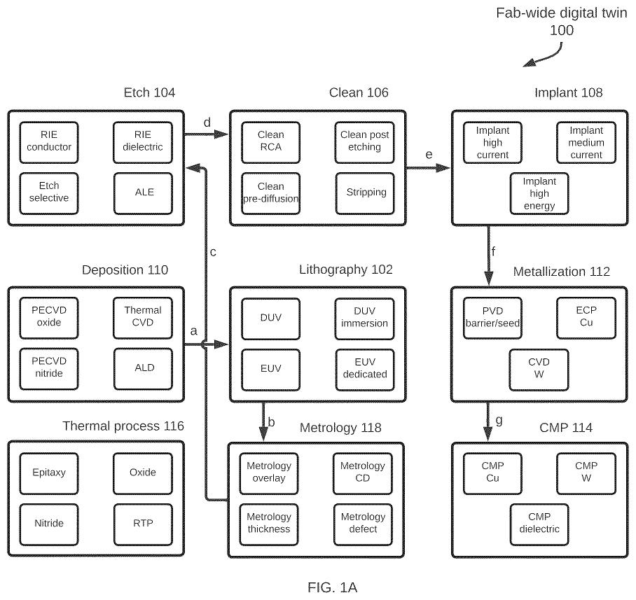

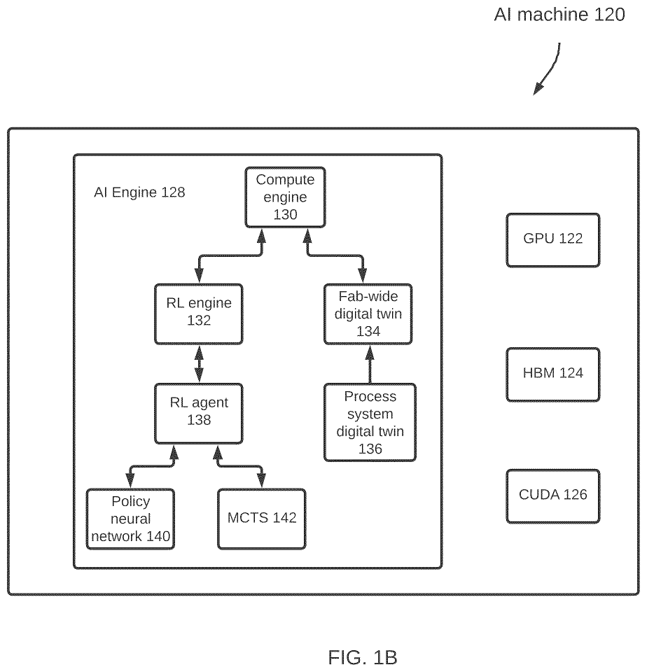

A Fab is a highly specialized environment where integrated circuits (ICs) are manufactured through a series of precisely controlled and interconnected processes. The primary objective of the Fab is to produce ICs with extremely high yield and reliability while maintaining the highest output and optimized cycle time. As shown in FIG. 1A, the key process systems within a Fab are organized into bays, which include lithography 102, etch 104, clean 106, implantation 108, deposition 110, metallization 112, chemical mechanical planarization (CMP) 114, thermal process 116, and metrology 118. Each of these process systems plays a crucial role in the step-by-step transformation of raw semiconductor wafers into fully functional ICs.
Lithography 102: Lithography is the cornerstone of semiconductor manufacturing, transferring circuit patterns onto the wafer's surface. Lithography bays include various systems such as extreme ultraviolet (EUV) scanners, deep ultraviolet (DUV) scanners, and DUV immersion scanners. Scanners are coupled with tracks for coating, baking, and developing photoresist layers.
Etch 104: Etching removes material from the wafer to create patterns. Techniques such as reactive ion etching (RIE) and atomic layer etching (ALE) ensure selective material removal, maintaining the integrity of non-targeted materials.
Clean 106: Cleaning removes contaminants at various stages. Methods include wet chemical baths, plasma cleaning, and RCA clean, among others, ensuring wafers are prepared for the next steps.
Implantation 108: Ion implantation modifies electrical properties by doping wafers with specific impurities, utilizing high current, medium current, and high energy implanters to tailor regions for transistor function.
Deposition 110: This step involves adding layers to the wafer surface. Techniques such as plasma-enhanced chemical vapor deposition (PECVD) and atomic layer deposition (ALD) are used to deposit materials like oxides, nitrides, or metals depending on the application.
Metallization 112: This step involves depositing metal layers, typically Cu or tungsten, to create electrical interconnections. These materials are deposited using methods like electrochemical plating (ECP) or chemical vapor deposition (CVD).
Chemical Mechanical Planarization (CMP) 114: CMP is used to achieve a flat, uniform wafer surface by combining chemical etching with mechanical abrasion, essential for multi-layer devices.
Thermal Process 116: Thermal processing includes steps like oxidation, annealing, and epitaxy, often conducted at high temperatures to modify wafer properties or grow thin films.
Metrology 118: Throughout fabrication, metrology tools monitor parameters such as critical dimensions (CD), film thickness, and overlay to ensure each process meets specifications.

These process systems operate in a coordinated sequence to transform raw wafers into functional ICs. Each step consumes capacity from a process system, and it is essential that the Fab dispatching system intelligently coordinates the movement of lots to minimize cycle time, maximize output, and meet OSD expectations.

FIG. 1A further illustrates an exemplary contact formation process involving the following steps:
1. Film Deposition: Deposition of an insulating layer, such as silicon dioxide (SiO₂), using techniques like PECVD within deposition bay 110.
2. Lithography to Define Contact Pattern: Lithography defines the contact pattern by exposing and developing a photoresist layer, transitioning from bay 110 to bay 102.
3. Measuring Overlay and CD: Metrology tools measure overlay and critical dimensions, transitioning from bay 102 to bay 118.
4. Etching to Form Contact Holes or Slits: Dielectric material is etched to form contact holes using RIE, transitioning from bay 118 to bay 104.
5. Cleaning: Post-etching cleaning is performed to remove etching residues, transitioning from bay 104 to bay 106.
6. Implantation: Optionally, ion implantation enhances ohmic contact, transitioning from bay 106 to bay 108.
7. Barrier Deposition: A barrier layer is deposited to prevent metal diffusion using PVD or ALD, transitioning from bay 108 to bay 112.
8. CVD Tungsten (W) Fill: Contact holes are filled with tungsten using CVD, transitioning within bay 112.
9. Chemical Mechanical Planarization (CMP): Excess tungsten is removed, creating a flat surface, transitioning from bay 112 to bay 114.

Throughout these steps, metrology tools in bay 118 monitor dimensions and quality to ensure the process meets performance specifications.

The Fab operates as a highly integrated system where each process system must function in harmony to produce high-quality ICs while meeting cycle time, output, and OSD targets. To manage and optimize this complex environment, a Fab-wide digital twin is employed, providing real-time insights and predictive capabilities for efficient lot dispatching.

A Fab-wide digital twin is a virtual model that represents the entire Fab, encompassing all process systems and their interactions. Each process system is mirrored by a corresponding digital twin. These process systems can be categorized into types, with each type delivering a consistent manufacturing capacity, typically measured as chambers per unit time (e.g., a dozen chambers operating over 24 hours). The manufacturing capacity for process systems of the same type is exchangeable. In one implementation, a single digital twin may represent all process systems of the same type, while in another, each process system may have a unique digital twin calibrated using data from sensors to reflect its specific characteristics.

The process system digital twin offers several features, including the ability to predict available capacity at a specific time. In one implementation, the Fab-wide digital twin can simulate Fab operations, including lot dispatching, using synthetic data. In another implementation, the digital twin is continuously updated with real-time data from the physical Fab, allowing it to accurately reflect current states of both process systems and lots. By simulating Fab behavior under various conditions, the Fab-wide digital twin provides valuable insights, identifying opportunities to optimize operations, reduce cycle times, and improve on-schedule delivery (OSD).

This holistic management tool integrates data from all process systems and enables analysis of the entire wafer journey, identifying bottlenecks, predicting equipment failures, and optimizing scheduling. Its predictive capabilities extend to maintenance, allowing for proactive equipment servicing based on usage patterns and history, thereby minimizing unplanned downtime.

FIG. 1B illustrates an embodiment of the AI machine 120, which is optimized for AI applications through advanced hardware and software modules. The hardware module includes integrated circuits like a GPU 122 and HBM 124, linked using advanced packaging technologies to achieve the necessary bandwidth for AI applications. The software modules include CUDA 126, enabling the AI machine to perform highly efficient parallel computing, which is critical for reinforcement learning (RL) algorithms.

The AI machine also includes an AI engine 128, typically implemented as software, which controls its operations through a compute engine 130. The AI engine further incorporates an RL engine 132, responsible for training a policy neural network 140 using an RL process that leverages the Fab-wide digital twin 134. The digital twin contains multiple process system digital twins 136. The RL engine also includes an RL agent 138, which manages the RL process. Additionally, an MCTS program 142 assists the RL agent in decision-making by working with the policy neural network.

In RL, an agent learns optimal behaviors by interacting with an environment through trial and error. The agent's objective is to maximize cumulative rewards over time by selecting actions that influence the environment's state. The environment represents the external system with which the agent interacts, characterized at any moment by a specific state. The state encapsulates all relevant information needed for decision-making, and the agent selects an action based on this state. The combination of a state and the agent's chosen action forms a state-action pair.

After taking an action, the environment transitions to a new state and provides feedback to the agent in the form of a reward. This reward is a scalar value indicating the benefit or cost of the action, and it may be received immediately or after several state-action pairs are generated. The agent's goal is to learn a policy that maps states to actions to maximize the expected cumulative reward over time.

To optimize the policy, the agent may use a policy neural network, which learns patterns between states and actions through training. The MCTS technique further enhances decision-making by simulating future actions and their outcomes, representing each possible future state and action as nodes in a tree structure. MCTS enables the agent to explore a broader range of potential outcomes, improving policy optimization.

In the context of the present invention, the environment includes two types of states: those describing the status of the process systems and those describing the status of the lots. A combined state incorporates both, providing comprehensive information for the RL agent to optimize Fab operations.

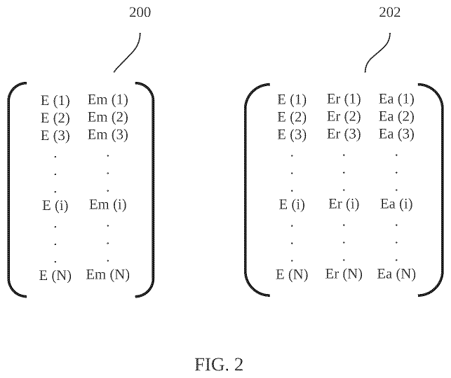

FIG. 2 depicts an exemplary expression of the states of process systems E(i) in the form of a matrix, denoted as 200. Each type of process system is associated with a maximum capacity Eₘ(i). Additionally, as illustrated in 202, at a specific time, the required capacity Eᵣ(i) and available capacity Eₐ(i) are also listed. This matrix representation efficiently tracks the dynamic states of the process systems, which is critical for the RL agent 138, to make informed decisions about lot dispatching and process optimization. The policy neural network 140 and the MCTS program 142 map these states to actions aimed at optimizing cycle time, throughput, and OSD.

The MCTS program 142 aids in decision-making by simulating future actions and outcomes, allowing the RL agent 138 to explore scenarios or cases and enhance policy optimization. By integrating AI and RL within the Fab's digital twin, this system continuously adapts to changes, optimizing operations to achieve the best cycle time, Fab output, and OSD.

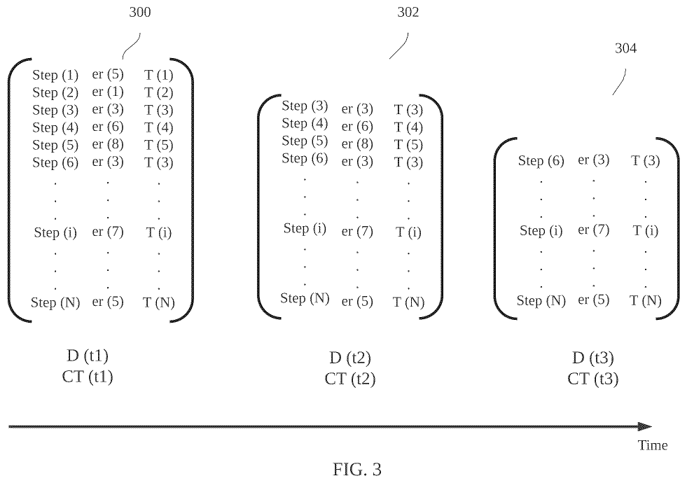

FIG. 3 shows an exemplary representation of the states of lots in the form of a matrix. Each lot includes a sequence of process steps denoted as Step(i) and each step is associated with a required capacity er(i) and duration T(i), where er(i) is a fraction of E(i). As shown in 300, 302, and 304, the number of process steps sequentially decreases as the lot progresses through designated process systems, which can be represented by a matrix with reduced height. As exemplified in FIG. 3, the delivery date or completion date at specific times, denoted as D(t₁), D(t₂), and D(t₃), can be predicted using the Fab-wide digital twin. Similarly, the cycle time at specific times, denoted as CT(t₁), CT(t₂), and CT(t₃), can also be predicted for the lot.

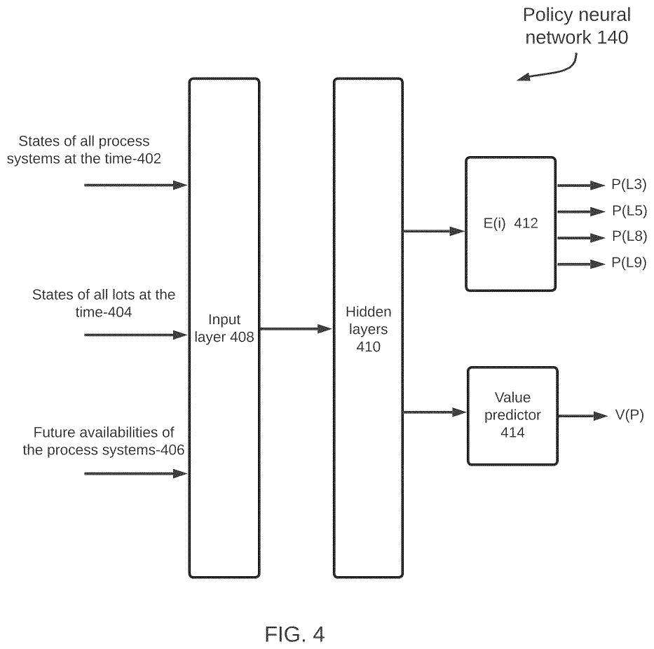

FIG. 4 showcases an exemplary policy neural network 140. At a specific time, one of the process systems, denoted as E(i), is available for taking a lot for processing. Several lots, exemplarily L3, L5, L8, and L9, are pending for selection, and a decision needs to be made by the policy neural network 140. The policy neural network 140 comprises an input layer 408, which takes three inputs. The first input, denoted as 402, includes the states of all process systems at the time. The second input, denoted as 404, includes the states of all lots in the Fab at the same time. In some implementations, this input may also include lots pending for their first process step in the Fab. The third input, denoted as 406, includes predicted future availabilities of the process systems. Scheduled preventive maintenance (PM) procedures and potential unscheduled downtime predicted by the process system digital twins can affect the cycle time. The predicted availabilities of the process systems can be represented by a matrix for a predetermined duration in the future from the current time. For example, the availabilities for the next day, week, or month. During training, unscheduled downtime may be simulated using a random number generator based on the statistical distribution of process system uptime performance. Once the policy neural network 140 is trained, unscheduled downtime can be determined based on real-time sensor measurements.

The policy neural network 140 further includes one or more hidden layers, denoted as 410, for processing the input data. The output layer of the policy neural network 140 is divided into two parts (412 and 414). The first part 412 is associated with the available process system E(i). Part 412 of the output layer determines a probability distribution for selecting lots waiting to be processed by the available process system. For example, as shown in FIG. 4, four lots (L3, L5, L8, and L9) are waiting in front of the process system E(i), and the output of 412 describes the probability of each lot among (L3, L5, L8, and L9) to be selected. Final selection is carried out using the MCTS program 142 based on the probabilities.

The output layer of the policy neural network 140 further includes a value predictor V(P) 414, which is designed to predict the value of the node based on the current policy represented by the policy neural network 140 with the current weights for the network.

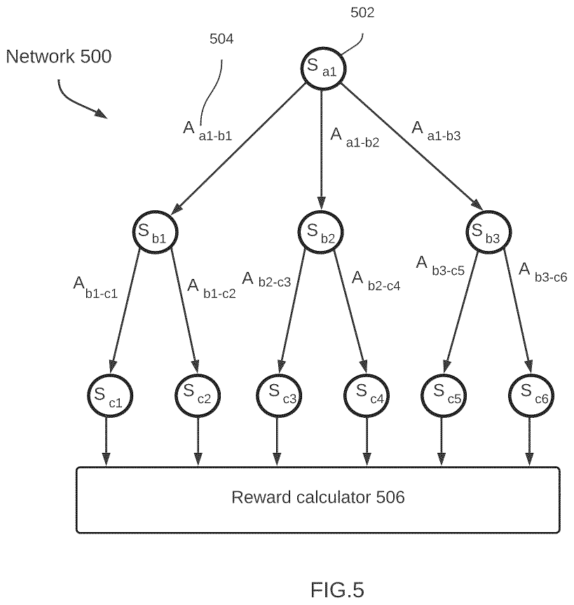

FIG. 5 schematically reveals a network 500 resulting from the RL process being rolled out through the MCTS program 142. As shown in FIG. 5, nodes like node 502 are represented by circles. Each node is associated with a combined state, such as Sa1Sa1 in the cycle. The state Sₐ₁ herein represents the combined states of the process systems and the lots at a selected time. A parent node can lead to multiple child nodes upon the execution of an action, like 504. For example, the node with state Sₐ₁ can transit into a node with state S_{b1} resulting from action A_{a1-b1}. The RL agent 142 manages the selection process through the policy neural network 140 and the MCTS program 142. For the training process, each action represents the exemplary selection of one of the lots from the pending lots for the available process system at the selected time. After the selection, the Fab-wide digital twin 134 is employed, and the states of the process systems and the lots are updated. The updated combined state is represented by node S_{b1}.

It should be noted that at each state, a different process system may be available. An action selected for loading up the available process system will convert the network 500 to a new state. Further, the completion of a lot in any process system will also convert the network to a new node and generate a pending action accordingly.

The process is repeated until reaching an evaluation node like S_{c1}, which triggers the RL agent 138 to evaluate performance and generate a reward using the reward calculator 506. In one implementation, the evaluation node is assigned if a predetermined number of actions have been executed. In another implementation, the evaluation node is assigned if a predetermined number of lots have completed all process steps. In still another implementation, the evaluation node can be assigned if a predetermined time is reached. For example, the evaluation node may be designed to be at a specific time of a day or week.

A reward can be designed based on a cost function. A cost function for cycle time and OSD optimization in a Fab can be defined as:

$$c = {\sum }_{i = 1}^{N} {w}_{i} {( \frac{{CT}_{i}}{{CT}_{itarget}} )}^{2} + {\sum }_{j = 1}^{N} {w}_{j} {( \frac{{D}_{j} - {D}_{itarget}}{{D}_{itarget}} )}^{2} , \qquad [ 1 ]$$

where c is the cost. The first term in Equation [1] is used for optimizing cycle time, and the second term is for optimizing OSD, where wᵢ and wⱼ are the weights for the first and second term, respectively. CTᵢ represents the predicted cycle time for each lot in the Fab, and the achieved cycle time for the lots that have completed all process steps between the two successive evaluation nodes. CT_{itarget} is the targeted cycle time for each lot. Dⱼ represents the predicted completion date for each lot, and the achieved completion date for the lots that have completed all process steps between the two successive evaluation nodes. D_{jtarget} is the targeted completion date for each lot.

A reward can be designed as:

$$R = f ( c ) , \qquad [ 2 ]$$

where R is the reward, and f is a function for determining the reward based on the cost c. In one implementation, the reward may be designed as multiple or many discrete numbers based on the cost. For example, the range of the cost can be divided into 10 intervals, each interval represented by an integer.

Each time the RL process reaches the evaluation node, the reward can be computed. Each state-action pair like (Sₐ₁, A_{a1-b1}), which is part of the state-action chain for the test case, receives the reward, where a test case is a chain of state-action between two evaluation nodes. A visit count for the pair will also be updated. After enough test cases are executed and an episode is completed, the average reward associated with each state-action pair can be calculated as the accumulated reward divided by the visit counts.

A Fab is typically an entity with continuous operations. After the reward is distributed, the network 500 can be expanded further from the evaluation node. In some implementations, the RL agent 138 may go back to certain nodes and regenerate actions from there. In other implementations, a new episode may be started.

The value associated with a node can then be calculated by averaging the reward across all state-action pairs originating from the node. These data can be employed to train the policy neural network 140 to prioritize generating actions with higher rewards.

In some implementations, the RL algorithm can be biased toward exploration rather than exploitation. For example, in a new episode, the initial weights for the policy neural network can be assigned randomly. This is useful to prevent the RL process from being trapped in a local optimum in the parameter space.

In other implementations, techniques like the ϵ-greedy algorithm may be employed to expand the search tree. The algorithm allocates a portion of the probability distribution to a completely random distribution, which is well-known in the art.

The training example here is for illustration only. In a real RL process, the number of nodes could be vast. The weights will be updated continuously to narrow down the selection of actions until the policy neural network 140 becomes more deterministic. Subsequently, the trained policy neural network can be generated for real-world applications.

The reward calculator 506 is typically implemented as software programs, managed by the RL agent 138.

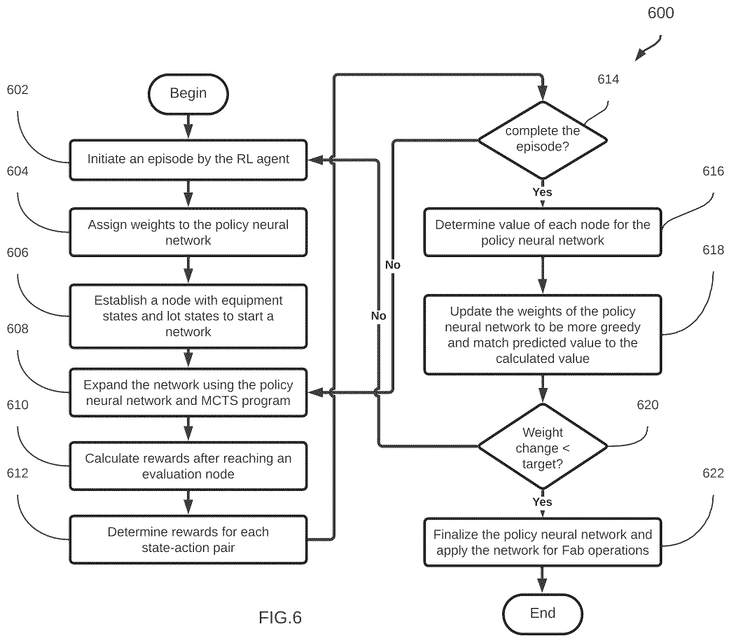

FIG. 6 showcases a flowchart for process 600, a self-initiated process for autonomously training the policy neural network 140 through an RL process. Process 600 starts with step 602, where the RL agent 138 initiates an episode for the RL process. An episode is represented by a network consisting of many nodes created by the RL agent 138 using the policy neural network 140 and the MCTS program 142. Each episode comprises many cases, defined as the state-action chain between two evaluation nodes, and typically includes a chain of actions and multiple intermediate combined states. A completed episode delivers the rewards associated with state-action pairs and the value of the nodes.

In step 604, initial weights are assigned to the policy neural network 140. In one implementation, the weights are assigned randomly. In another implementation, the weights are based on a previous RL episode, enabling continuous improvement, making the policy neural network 140 generate actions more focused on increasing rewards.

In step 608, an initial node for a network is established. The initial node is associated with initial states for both the process systems and the lots. At this point, the RL agent 138 applies the policy neural network 140 to generate probability distributions for each lot pending processing in the available process system. Based on these distributions, the MCTS program 142 is employed to generate an action for selecting lots. A random number generator is typically used based on the distributions to generate the action. Subsequently, the RL agent 138 applies the action by leveraging the Fab-wide digital twin 134 to generate the next node with a new state. The process repeats until a case is completed.

In step 608, the network 500 is progressively expanded using the policy neural network 140 and the MCTS program 142. Each state-action pair of the network is associated with a visit count. Some state-action pairs are involved in more than one case, which is accounted for by the visit count.

In step 610, rewards are calculated using the reward calculator 506 for all completed cases. If the state-action pair is involved in a specific case, it receives the reward accordingly in step 612. The reward accumulates as the visit count increases. The average reward for a specific state-action pair is the accumulated rewards divided by the visit count.

In step 614, the RL agent 138 determines if the episode is complete. A simple criterion for ending an episode may be related to the number of cases in the episode. If the result is negative, the RL agent 138 continues to expand the network. Otherwise, the RL agent 138 determines the value for each combined state in step 616. For each node associated with a combined state, the RL agent 138 has established relationships between state-action pairs and their associated rewards. The value of the node, based on the current policy neural network, can be computed as the average of the rewards across all state-action pairs.

In step 618, the RL agent 138 updates the weights of the policy neural network 140 based on all available state-action pairs. At each node, the states are inputs for the policy neural network 140, and a set of softmax/logistic function parameters are the outputs. The output also includes the predicted value. The updated weights should make the policy neural network 140 greedier for generating actions with higher value and predicting the value more accurately. As the policy neural network 140 improves, it becomes more deterministic in selecting an action from a group of available actions to generate the highest reward. This becomes a typical classification problem, so the cost function for updating the policy neural network 140 includes a cross-entropy loss function and a square error for the value. The policy neural network 140 can be trained by leveraging rewards associated with all actions from the node. In one implementation, the earlier nodes may carry heavier weight during training to be consistent with a discount rule.

In step 620, the RL agent 138 evaluates if the weights have converged to give a deterministic policy neural network. If the result is negative, the RL agent 138 can initiate a new episode to repeat the process and generate more data through further exploration. In one implementation, an ex-greedy algorithm may be employed to encourage exploration over exploitation. In another implementation, a new set of initial weights for the policy neural network 140 may be applied. In yet another implementation, the weights generated from the previous episode may be used together with the ε-greedy algorithm.

If the evaluation in step 620 is positive, the policy neural network 140 is finalized in step 622. The trained policy neural network 140 can then be generated and subsequently deployed for real-world Fab operation.

1. A lot dispatching system in a semiconductor Fab, comprising:
an AI machine including an AI engine;
a Fab-wide digital twin comprising models of various process systems, grouped by types based on manufacturing capacity available for processing a plurality of lots; and
a policy neural network configured to generate outputs representing the probability of selecting a lot for processing in an available process system, wherein the policy neural network is trained using a self-initiated reinforcement learning (RL) process by an RL agent within the AI engine, leveraging data generated by the digital twin.

2. The system of claim 1, wherein the policy neural network comprises an input layer, a plurality of hidden layers, and an output layer, wherein the output layer generates outputs describing softmax and/or logistic functions for probability distributions of lots awaiting selection for processing by the available process system.

3. The system of claim 2, wherein the self-initiated RL process further includes a Monte Carlo Tree Search (MCTS) program, which selects the lots to be processed based on the probability distributions.

4. The system of claim 3, wherein the policy neural network includes states of the process systems and states of the lots as inputs, wherein the states of the process systems further include the available capacities for each type, and the states of the lots include uncompleted process steps and required capacity for each step, wherein the states define a node in a network representing a plurality of state-action pairs.

5. The system of claim 4, wherein the policy neural network further includes an additional input for predicting availabilities of the process systems for a predefined future duration.

6. The system of claim 5, wherein the availabilities of the process systems are determined using the digital twins of the process systems.

7. The system of claim 4, wherein selecting a lot for processing constitutes an action, and the RL agent virtually executes the action using the Fab-wide digital twin, updating the states of the process systems and the lots, generating a new node in the network.

8. The system of claim 2, wherein the policy neural network further includes a value predictor for assessing the quality of the action.

9. The system of claim 1, wherein the process systems comprise lithography, etching, deposition, cleaning, implantation, diffusion, metallization, chemical mechanical planarization (CMP), and metrology.

10. A method for dispatching lots in a semiconductor Fab, comprising:
initiating, by an RL agent of an AI engine in an AI machine, an episode for training a policy neural network through an RL process, wherein the episode includes a plurality of simulated cases leveraging a Fab-wide digital twin, and wherein the Fab-wide digital twin includes digital twins for various types of process systems;
assigning, by the RL agent, weights to the policy neural network, wherein the policy neural network includes an input layer, a plurality of hidden layers, and an output layer, and wherein the output layer includes outputs describing softmax or logistic functions for generating probability distributions of the lots to be selected for processing by an available process system;
establishing, by the RL agent, a node associated with the states of the process systems and the states of the lots, and expanding the node into a network comprising a plurality of nodes consisting of a plurality of state-action pairs, wherein the RL agent employs the policy neural network and a Monte Carlo Tree Search (MCTS) program to form the state-action pairs, and wherein the states are generated based on the Fab-wide digital twin;
calculating, by the RL agent, a reward for each case, wherein the case includes a chain of state-actions, and wherein the last state is a terminal state meeting criteria for the reward calculation;
determining, by the RL agent, a reward for each state-action pair;
determining a value for each node after the episode is completed;
updating the weights of the policy neural network by leveraging the determined rewards for the state-action pairs and the value for the node, whereby the updated policy neural network becomes more efficient in generating actions with higher value;
finalizing the policy neural network after the RL process has converged; and
applying the trained policy neural network for real-world applications.

11. The method of claim 10, wherein the policy neural network further includes an additional input for the predicted future availabilities of the process systems, wherein these availabilities are generated based on the digital twins of the process systems.

12. The method of claim 10, wherein the policy neural network further includes a value predictor as an output, wherein the updated weights further improve the accuracy of the value predictions.

13. The method of claim 10, wherein multiple episodes are executed to train the policy neural network through reinforcement learning process, with each episode comprising several simulated cases leveraging the Fab-wide digital twin.

14. The method of claim 10, wherein the RL agent employs strategies to encourage exploration during the training process, including the use of an ϵ-greedy algorithm to balance exploration and exploitation.

15. The method of claim 10, wherein the process system digital twin comprises models for lithography, etching, deposition, cleaning, implantation, diffusion, metallization, chemical mechanical planarization (CMP), and metrology, each representing the respective process systems in the Fab.

16. An AI machine for coordinating operations of a Fab, comprising:
an AI engine comprising a compute engine, wherein the compute engine utilizes a GPU, a high-bandwidth memory (HBM), and a compute unified device architecture (CUDA);
an RL agent, part of the compute engine, designed to conduct a self-initiated reinforcement learning process to train a policy neural network, wherein the trained policy neural network generates probability distributions for selecting lots pending for processing using an available process system; and
a Fab-wide digital twin that generates synthetic data to support the reinforcement learning process, wherein the Fab-wide digital twin comprises digital twins for various process systems in the Fab.

17. The AI machine of claim 16, wherein the RL agent employs a Monte Carlo Tree Search (MCTS) program to explore possible future states and actions, building a network of state-action pairs to guide decision-making in lot dispatching.

18. The AI machine of claim 16, wherein the policy neural network includes an input layer with multiple inputs, a plurality of hidden layers, and an output layer with probability distributions, wherein the inputs further comprise states of the process systems, states of the lots, and predicted future availabilities of the process systems for a predefined time window.

19. The AI machine of claim 16, wherein the process system digital twin further includes models for lithography, etching, deposition, cleaning, implantation, diffusion, metallization, chemical mechanical planarization (CMP), and metrology, each represents a type of process system, and each can be optionally calibrated based on real-time data.

20. The AI machine of claim 16, wherein the process system digital twins further include mechanisms to predict future states based on measured data from sensors within the process systems, providing real-time feedback to the reinforcement learning process after the policy neural network is trained.
